(19) United States
(12) Patent Application Publication
(10) Pub. No.: US 2001/0032104 A1
(43) Pub. Date: Oct. 18, 2001

(54) System and a method for scheduling and managing the overnight accommodation of traveling personnel away from home base

(76) Inventors: Ralph Michael Hall, Houston, TX (US); Conrad Kenyon Zeiler, Seabrook, TX (US)

Correspondence Address: ANASTASSIOS TRIANTAPHYLLIS, P.O. Box 27629, HOUSTON, TX, 77227, US

(21) Appl. No.: 09/790,447

(22) Filed: Feb. 21, 2001

Related U.S. Application Data
(60) Provisional application No. 60/184,013, filed on Feb. 22, 2000.

(51) Int. Cl. G06F 17/60

(52) U.S. Cl. 705/5; 705/9; 705/40

(57) ABSTRACT

A computer program, a computer system and a method are disclosed for scheduling and managing the overnight accommodation of people in establishments providing lodging. The program, system and method may be used by any organization or business entity having personnel that travel on a regular basis with overnight layovers away from home base, such as an airline, or any organization or business entity that manages or schedules the overnight accommodations of people in establishments providing lodging.

In an airline operation, a computer program at a facility of the airline assigns layovers to specific hotels and creates the required reports for each hotel. These reports reports are packaged in a digital archive for each hotel which is placed on a magnetic material or an optical storage material for transfer to the hotel, is sent to the hotel via E-mail or is placed in a location on the INTERNET for access by the hotel or in a digital storage area accessible by the hotel. A computer program installed in the hotel accepts and processes the packaged file to generate reports and sheets to be used by the hotel.

### RELATED PRIORITY DATE APPLICATION

This application claims the benefit under 35 U.S.C. 119(e) of U.S. provisional application Ser. No. 60/184,013 filed on Feb. 22, 2000.

### TECHNICAL FIELD OF THE INVENTION

The present invention relates to the fields of computer programs and systems and methods of doing business therewith and, more particularly, to a computer program, a computer system and a method for scheduling and managing the overnight accommodation of traveling personnel in establishments providing lodging, such as hotels, motels or the like, when they are away from home base. Still more particularly, the present invention discloses a computer program and a computer system that generates a data file containing scheduling data for a specific time period for each establishment that is transmitted or transferred to the particular establishment by placing it and transferring it to the establishment on a magnetic material (floppy, zip disk tape etc.) or an optical storage material (CD-ROM), via E-mail or by placing it in a location on the INTERNET for access by the hotel or in a digital storage area accessible by direct network connection by the establishment. A second program installed in the computer system of the establishment accesses the date file and generates several reports in accordance with the present invention.

### BACKGROUND OF THE INVENTION

An airline flight crew on a multiple day pairing must stay at rooms at an establishment providing lodging such as a hotel, motel or other overnight facility during their crew rest periods. Airlines contract for these rooms and make the determination of room requirements based on the pairings they have created for assignment to the flight crew members. In the past, these room requirements were generated in the facilities of the airline and were sent to each lodging establishment such as a hotel in a paper form, listing the days of the month, the number of rooms required and the times that the crew members will be arriving. The lodging establishment had the difficult and time consuming task of creating manually a crew pick up report, a crew drop off report and daily sign-in sheets.

In addition, an airline may have contracted with more than one lodging establishment in a city due to scarcity of rooms in one lodging establishment or to fulfill other requirements such as need to keep morning flight crew together in one lodging establishment and evening flight crews together in another lodging establishment or labor union contract obligations that require lodging accommodations near the airport for short layovers and in a city for long layover. The division of lodging establishment assignments is a labor intensive process.

Further, the airlines conduct detailed auditing of lodging establishment usage to determine the accuracy of the charges, the overpayment of charges including taxes and, in general, to ensure that they minimize the accommodation costs.

The preparation and review of manual reports by the airline and the establishments that provide the lodging is very time consuming, labor intensive, inefficient and prone to error. Furthermore, the manual processing of those reports by the lodging establishments and airlines limit the ability of the airlines to manage and audit layover room usage resulting in increased expense and resource mismanagement.

According to the present invention, a computer program and a computer system is disclosed that generates a data file containing scheduling data for a specific time period for each establishment that provides lodging. The data file is transmitted or transferred to the particular establishment by placing it and transferring it to the establishment on a magnetic material (floppy, zip disk tape etc.) or an optical storage material (CD-ROM), via E-mail or by placing it in a location on the INTERNET for access by the establishment or in a digital storage area accessible by direct network connection by the establishment. A second program installed in the computer system of the lodging establishment accesses the date file and generates several reports which are utilized to manage, schedule and audit, efficiently and expeditiously, the overnight accommodation and costs of flight crews.

These and other advantages of the present invention will become apparent from the following description and drawings. The present invention was developed to change this process.

### SUMMARY OF THE INVENTION

A computer program, a computer system and a method are disclosed for scheduling and managing the overnight accommodation of people in establishments providing lodging. The program, system and method may be used by any organization or business entity having personnel that travel on a regular basis with overnight layovers away from home base or any organization or business entity that manages or schedules the overnight accommodations of people in establishments providing lodging. Specific entities include, but are not limited to, carriers such as commercial airlines, air freight carriers, letter or package couriers and any other similar business that utilizes crews that have overnight layovers away from home base. The establishment providing lodging can be a hotel, a motel or any similar establishment.

In a commercial airline operation, a computer program is installed in a computer at a facility of the airline. The computer program contains modifiable data including the cities where the airline flies; the primary hotel or hotels that may be used in a particular city, the telephone and telecopier numbers for each hotel; the alternate hotels and its priority in a particular city; the starting and termination dates of the contract between each hotel and the airline; the type of airplanes flown by the carrier and crew personnel; and the name and telephone number of any third party providing transportation between the airport and the hotel.

The program is activated to access a database that contains the pairings data. The program parses each pairing and determines the length of the scheduled layover for each city. The rules that determine if multiple hotels are to be used for a specific city are then input to the program. The program combines the previously saved pairing information and the rules to assign layovers to specific hotels. Room requirements are determined and the system creates the required reports for each hotel. These reports include a hotel summary containing the flight number, arrival time, length of stay, departure time, departure flight number, number of rooms required and the date they are required; a sign-in sheet with a line for each crew member containing the arriving flight number, scheduled arrival time, departing flight number and scheduled departure time and spaces for manual entry of a time for hotel departure, crew member name, crew member employee identification information, crew base information, smoking or non-smoking room request, assigned room number and hotel accounting information; a crew pickup schedule containing the scheduled arrival time and the flight number of a flight and the total number of crew members to be picked up; a crew drop-off schedule containing the time the crew members need to be at the airport, the departure flight number and the total number of crew members and spaces for manual entry of departure time from the hotel, a van or driver number and a driver name; and a blank sign-in sheet for back up. These preformatted reports and sheets are packaged in a digital archive with one package for each hotel. The packaged file for each hotel is placed on a magnetic material or an optical storage material for transfer to the hotel, is sent to the hotel via E-mail or is placed in a location on the INTERNET for access by the hotel or in a digital storage area accessible by the hotel. A computer program installed in each hotel accepts and processes the packaged file to review and generate the reports and sheets. The system further facilitates the creation of a monthly invoice by the hotel that contains entries made by the hotel including the hotel name, billing address, billing contact name, number of scheduled rooms used, number of unscheduled rooms used, rooms subject to tax, state, county city and other taxing information, and contracted room costs. At the end of the time period, a standardized invoice is generated and sent back to the airline with the filled in sign-in sheets to facilitate bill payment and detailed auditing of the airline's room usage.

The system further creates for use by the carrier other lists and reports including a list of all primary contracted hotels, a list of all primary and alternate contracted hotels, a carrier room requirement for a particular time period, and a provisioning report which is generated for each destination city on a daily basis for reporting the deposits of money received from the sale of drinks in flight.

### BRIEF DESCRIPTION OF THE DRAWINGS

For a detailed description of the invention, reference will be made to the accompanying drawings wherein:

FIG. 1 is a flow chart showing the generation of the hotel information files in accordance with the present invention;

FIGS. 2A, 2B and 2C show a typical hotel summary sheet in accordance with the present invention;

FIG. 3 is a typical sign-in sheet for pilots (cockpit crew members) in accordance with the present invention;

FIG. 4 is a typical sign-in sheet for attendants (cabin crew members) in accordance with the present invention;

FIG. 5 is a typical crew pick up schedule in accordance with the present invention;

FIG. 6 is a typical crew drop-off schedule in accordance with the present invention;

FIG. 7 is a typical invoice in accordance with the present invention;

FIGS. 8A and 8B show a typical hotel list in accordance with the present invention; and

FIGS. 9A and 9B show a typical provisioning report in accordance with the present invention.

### DETAILED DESCRIPTION OF THE PREFERRED EMBODIMENTS

The present invention discloses a computer program, a computer system and a method for scheduling and managing the accommodation of the crews of a carrier for overnight layovers in establishments providing lodging such as hotels, motels or other similar establishments. The carrier may be a commercial airline company, an air freight company, a letter or package courrier or any other business that utilizes crews that have overnight layovers away from home base. Similarly, the computer program, the computer system and the method may be used by any organization or business entity having personnel that travel on a regular basis with overnight layovers away from home base or any organization or business entity that manages or schedules the overnight accommodations of people in establishments providing lodging. The present invention will now be described in connection with a typical utilization by a commercial airline company to manage accommodations in hotels. It should be understood, however, that other users referred to above may utilize the program, the system and the method similarly in connection with any establishment providing lodging, with some modifications to reflect their particular requirements.

Several terms are used herein which are well known in the airline industry. Some of those terms are further defined herein to further clarify the invention, as follows:

“Crew member or flight crew member” is a member of a flight crew i.e., a pilot, a flight engineer, a mechanic, a navigator, a steward or a flight attendant who is assigned to a specific flight.

“Cockpit crew member” is a pilot, a flight engineer, a mechanic, or a navigator.

“Cabin crew member” is a steward or a flight attendant.

“Crew rest” is the period of time in a pairing (defined hereinafter) between days that the crew member is not assigned flying.

“Leg” is one flight between two cities.

“Day” is the series of legs that are flown by a crew member in a continuous flow, unbroken by a period of crew rest.

“Pairing or trip” is a series of legs spanning a single or multiple days.

“Line or line of flying” is a series of pairings assigned to specific dates over a finite period, usually a calendar month, that are assigned to an individual crew member.

“Layover or overnight” is the period of crew rest between days on a multiple day pairing and which is usually spent in a hotel that the airline has a contract with for the accomodation of crew members.

“Crew base” is the assigned work location of a crew member.

“Terminator leg” is the last leg of day of flying that ends in a crew member's crew base and is the last leg of a pairing.

In a commercial airline operation, a computer program in accordance with the present invention is installed in a computer at the offices of the airline department handling crew scheduling, billing or related matters. The computer program includes data that can be periodically modified to reflect updates or the like. The data includes the following:

1. the cities where the airline flies;

2. the primary hotel or hotels that may be used in a particular city;

3. the telephone and telecopier numbers for each hotel;

4. the alternate hotels that maybe contacted in a particular city in the event that the primary hotels are not available and the priority of each alternate hotel;

5. the starting and termination date of the contract between the particular hotel and the airline regarding overnight accomodations;

7. the type of airplanes flown by the carrier and the type and number of crew personnel (i.e cockpit versus cabin crew members) associated with a type of airplane; and

8. the name and the telephone number of any third party, other than the hotel, that would provide the transportation from a particular airport to a particular hotel and vice versa.

Some cities have more than one primary hotel for the purpose of, among other things, satisfying certain rules of the splitting of layovers. Those rules are based on factors such as, day of the week of the layover, the need or not to keep the morning and afternoon crews together (AM/PM rules), and the length of the layover. The program has appropriate inputs for receiving interactively the information setting forth the applicable rules, if any, from the user of the program to generate the information described hereinafter.

In operation, the program is activated to access a database that includes the pairings data files for each crew member of the airline for a finite period of time which is usually one month. Each pairing comprises a series of legs. The information for each leg consists of flight number, type of airplane, departure city, departure time, arrival city and arrival time. A pairing further includes the calendar dates of operation. Each pairing is identfied by a unique alpha-numeric identifier and each pairing for a particular crew member originates and ends in the crew base of the crew member.

Upon receiving as input the pairing information for the specific period of flying (usually a calendar month),the program parses each pairing examining each leg to determine if that leg is the last leg before the beginning of crew rest. The system then parses the next leg and determines the length of the scheduled layover. The arrival city is saved along with arriving flight number, next day departing flight number, arrival time, departure time, airplane equipment type, crew member position, i.e. cabin crew member or cockpit crew member, length of the layover and date of operation for all the current pairings.

As previously explained, the program is adopted to respond to a set of rules that determine if multiple hotels are to be used for a specific city. These rules may be based on the length of a layover or whether the morning and evening crews are to be kept together. The rules may be different for each day of the week, i.e. different rules for Monday through Friday than Saturday and Sunday. The appropriate input is then made to the program to address those rules for a specific city.

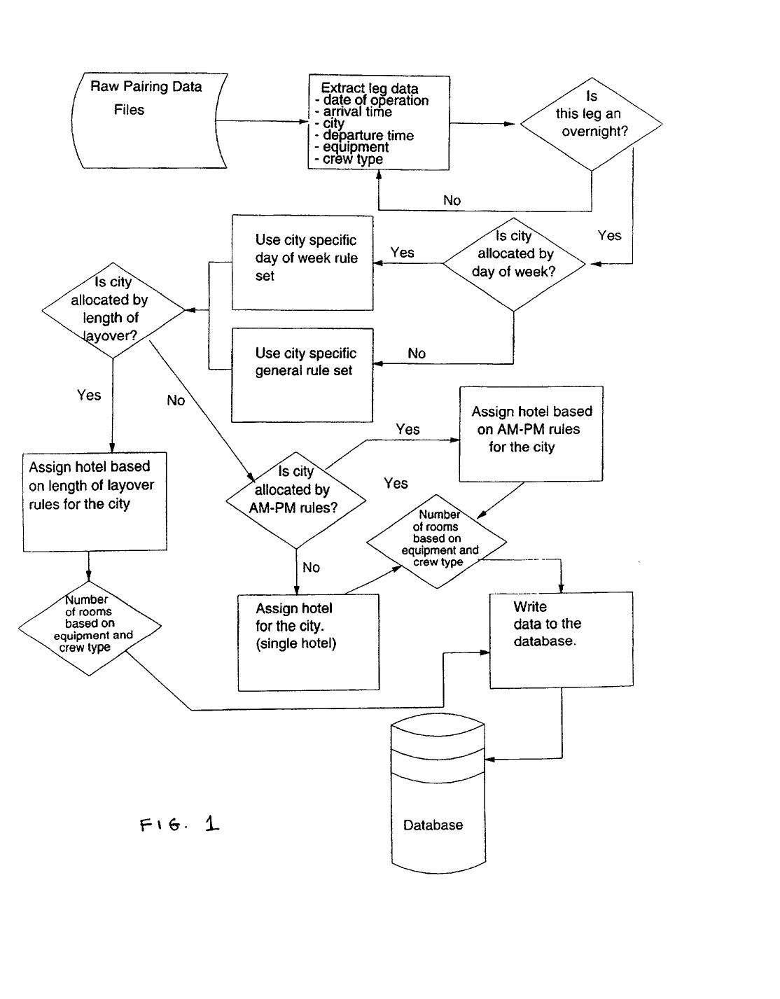

The program then combines the previously saved pairing information and the rules to assign layovers to specific hotels. Room requirements are determined by the type of airplane equipment which determines the number of crew members that are assigned to that pairing. The system then creates the required reports for each hotel for the specific time period. FIG. 1 shows a flow chart of the process for generating the reports from the pairings and the rules of allocation. These reports include the following:

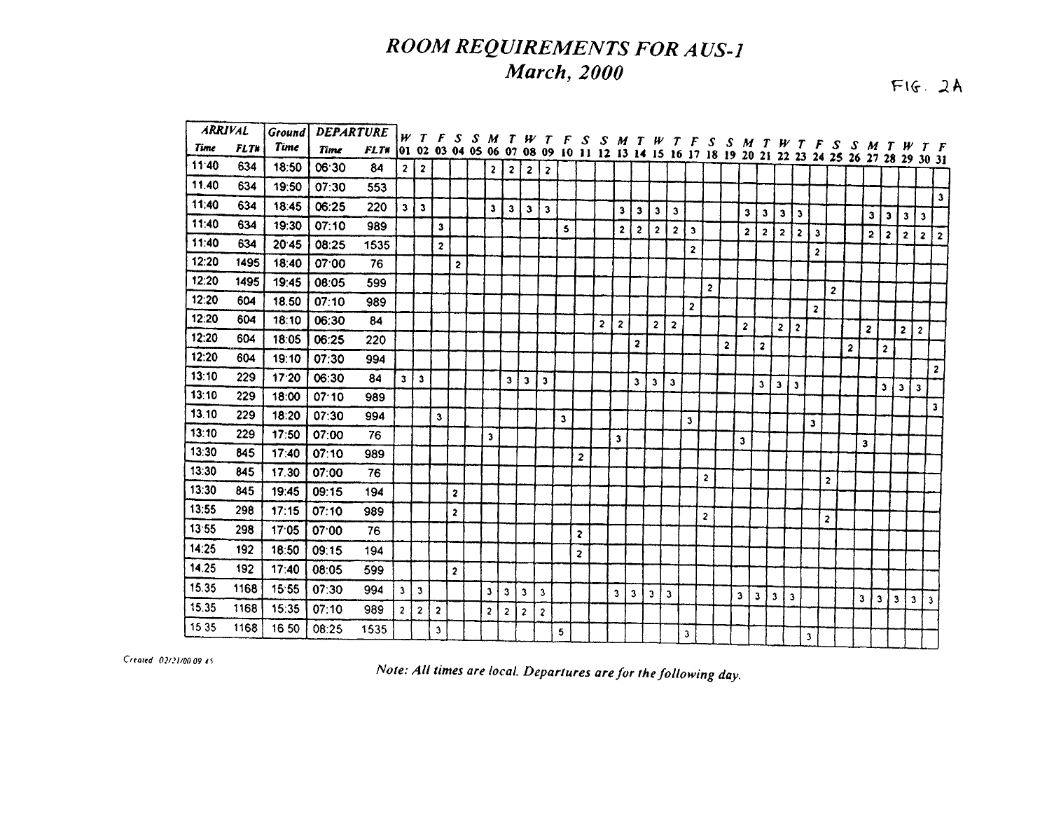

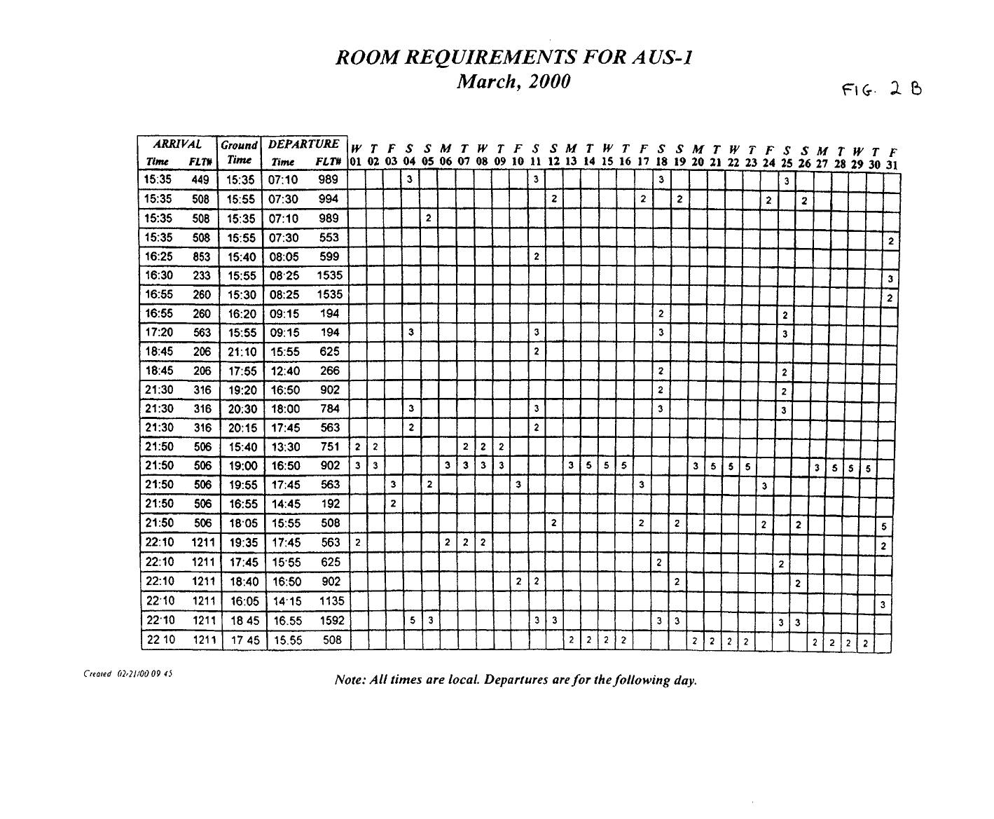

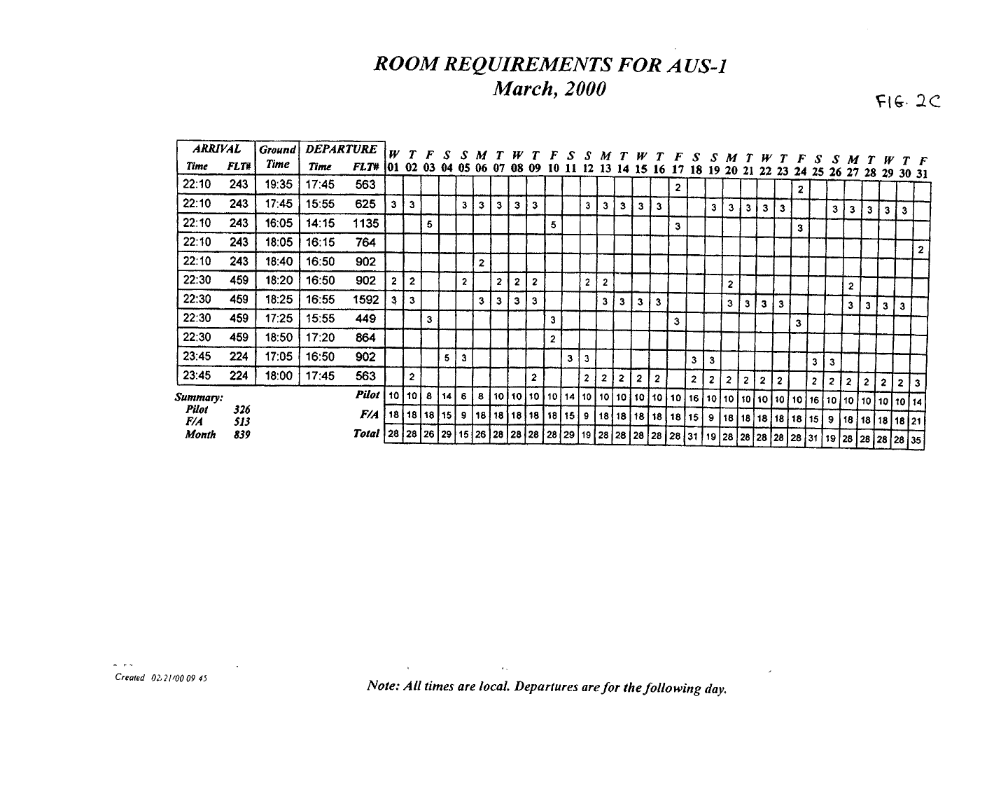

Hotel Summary. It contains the flight number, arrival time, length of stay, departure time, departure flight number, number of rooms required and the date they are required. A typical hotel summary sheet is shown in FIGS. 2A, 2B and 2C.

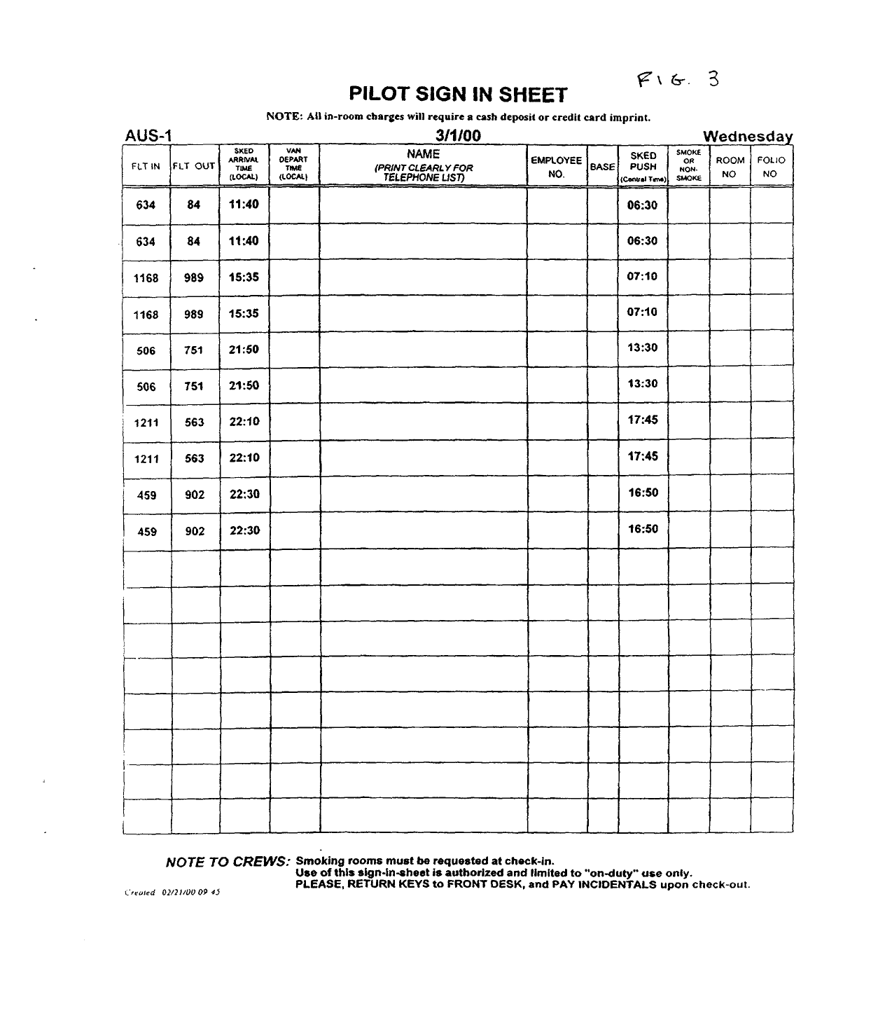

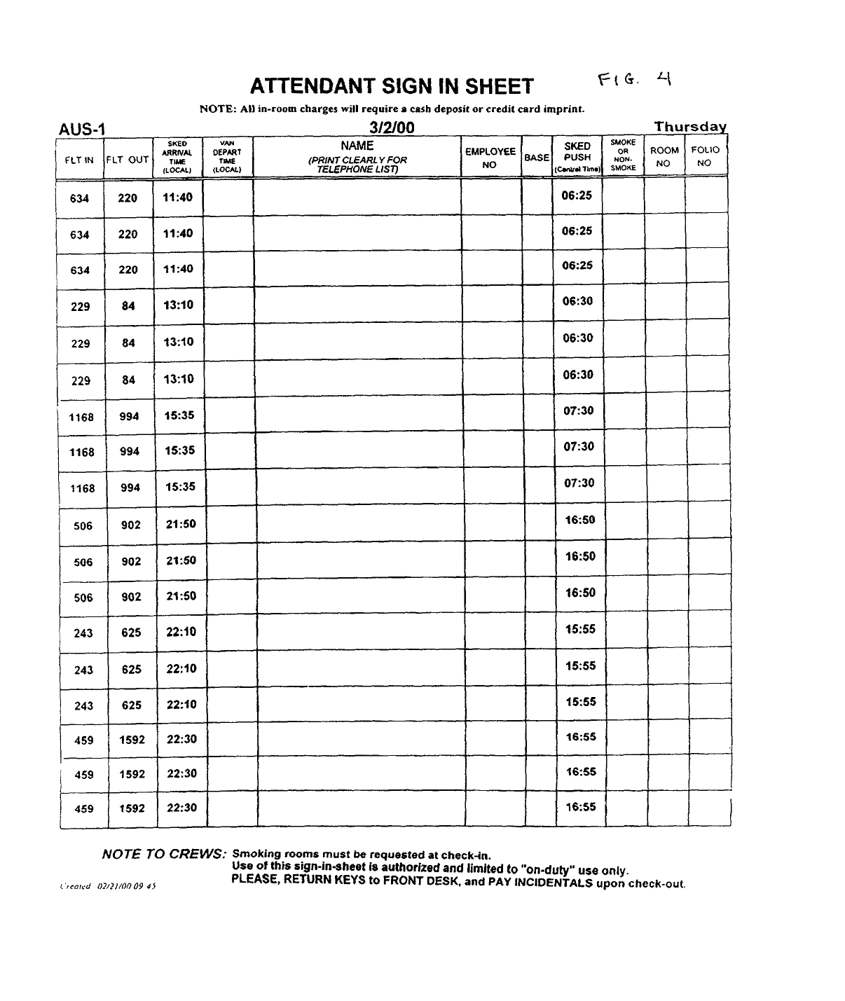

Sign-In Sheet. A sheet of paper that a crew member would place his name, time of arrival, employee ID number flight number and other pertinent information for his check in at a layover hotel. It is used by the hotel to place the crew member information into their reservation system. It is also used by the hotel to account to the airline the number of rooms used and to create an invoice for the airline to pay. It is used by the airline to reconcile rooms scheduled versus rooms used and billing. The sign-in sheet generated in accordance with the present invention contains the arriving flight number, scheduled arrival time, departing flight number and scheduled departure time. A space is available for manual entry of a time for hotel departure, crew member name, crew member employee identification information, crew base information, smoking or non-smoking room request, assigned room number and hotel accounting information. A line is generated for each individual crew member based on the saved pairing information. The lines of information are organized and separated by calendar dates. One sign-in sheet is generated for cockpit crew members and another one is generated for cabin crew members. A typical sign-in sheet for pilots (cockpit crew members) is shown in FIG. 3. A typical sign-in sheet for attendants (cabin crew members) is shown in FIG. 4.

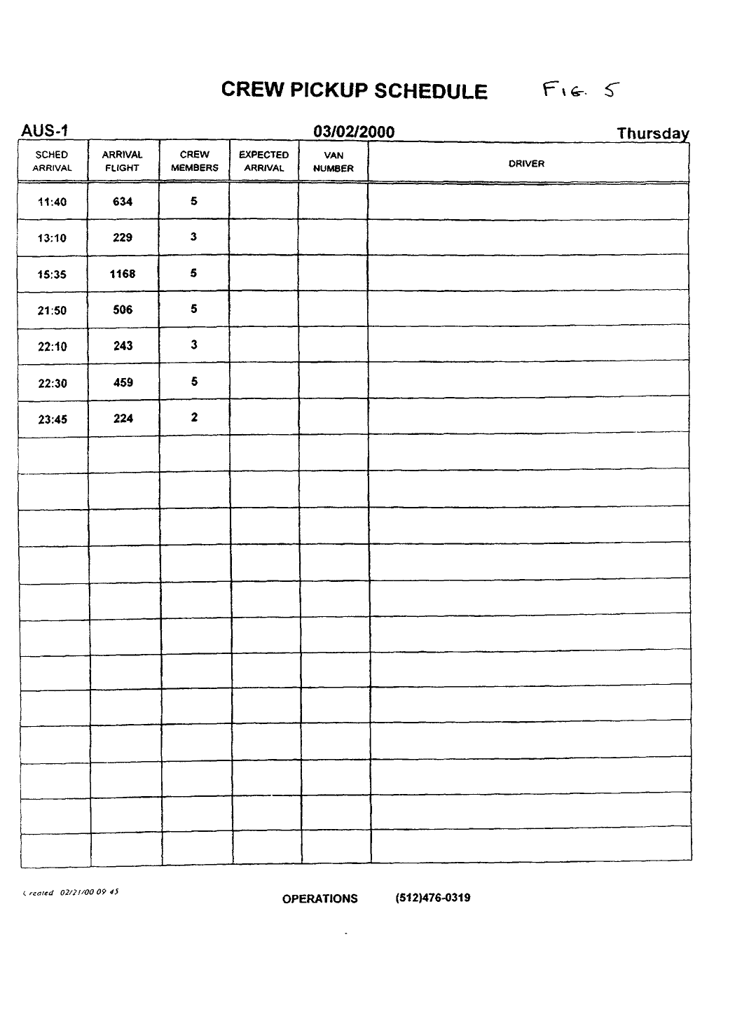

Crew Pickup Schedule. It contains the scheduled arrival time of a flight, the arrival flight number and the total number of crew members to be picked up. A hotel uses the schedule to schedule a driver to transport crew members from the airport to the hotel. It has spaces for manual entry of a changed arrival time, a van or driver number and a driver name. A line is generated for each arriving flight. The lines of information are organized and separated by calendar dates. A typical crew pick up schedule is shown in FIG. 5.

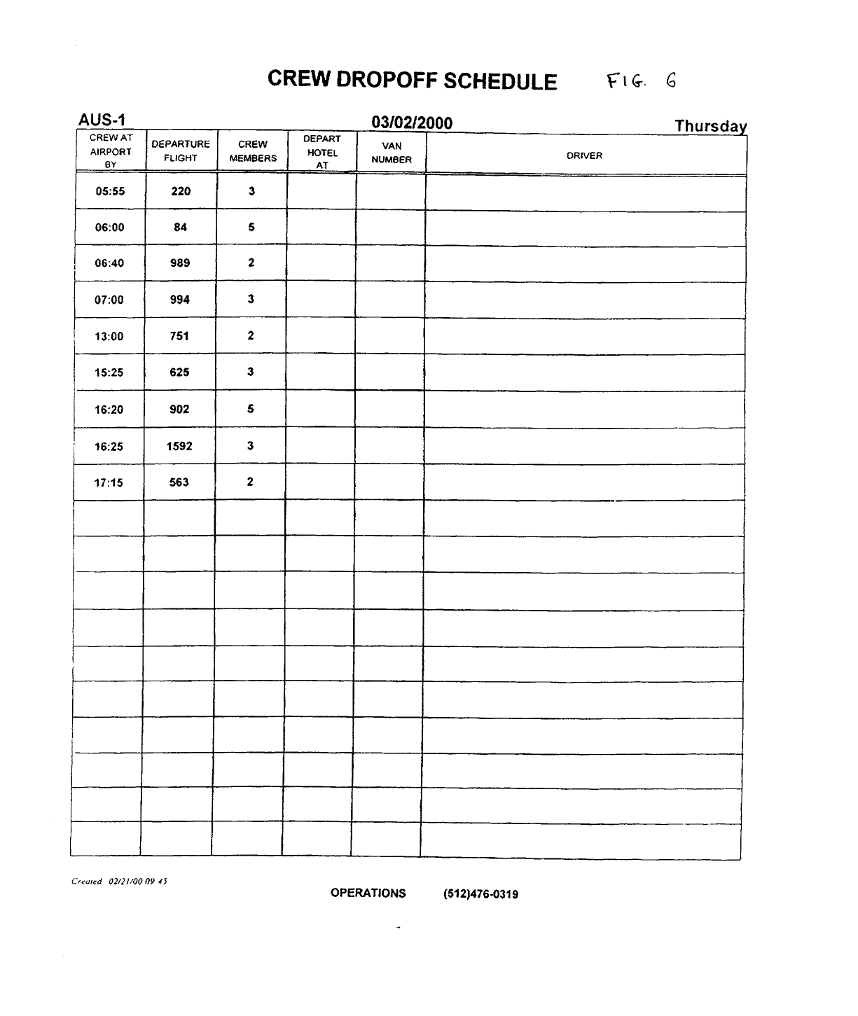

Crew Drop-off Schedule. This report contains the time the crew members need to be at the airport, the departure flight number and the total number of crew members. A hotel uses it to schedule a driver to transport crew members from the hotel to the airport. It has spaces for manual entry of departure time from the hotel, a van or driver number and a driver name. A line is generated for each departing flight. The lines of information are organized and separated by calendar dates. A typical crew drop-off schedule is shown in FIG. 6.

Blank Sign-In Sheet. This is the same as the sign-in sheet except it has no generated information. It is used as a back up in case the generated reports are not available.

The above preformatted reports and sheets for each hotel are packaged in a digital archive with one package for each hotel. New reports are generated and sent or made available for access for each and every period, usually one calendar month. The packaged file for each hotel is placed on a magnetic material (floppy, zip disk tape etc.) or an optical storage material (CD-ROM) for transfer to the hotel, is sent to the hotel via E-mail or is placed in a location on the INTERNET for access by the hotel or in a digital storage area accessible by direct network connection by the hotel.

A digital program is provided and installed in the computer system of each hotel for accepting the packaged file provided to the hotel in any of the aforementioned media (magnetic material, optical storage material, E-mail, INTERNET or direct network connection) and processing the packaged file to review and generate the enclosed reports and sheets. Once the packaged file is accessed by the program which is installed in the hotel computer system, the hotel has the ability to select which report or sheet to print or view.

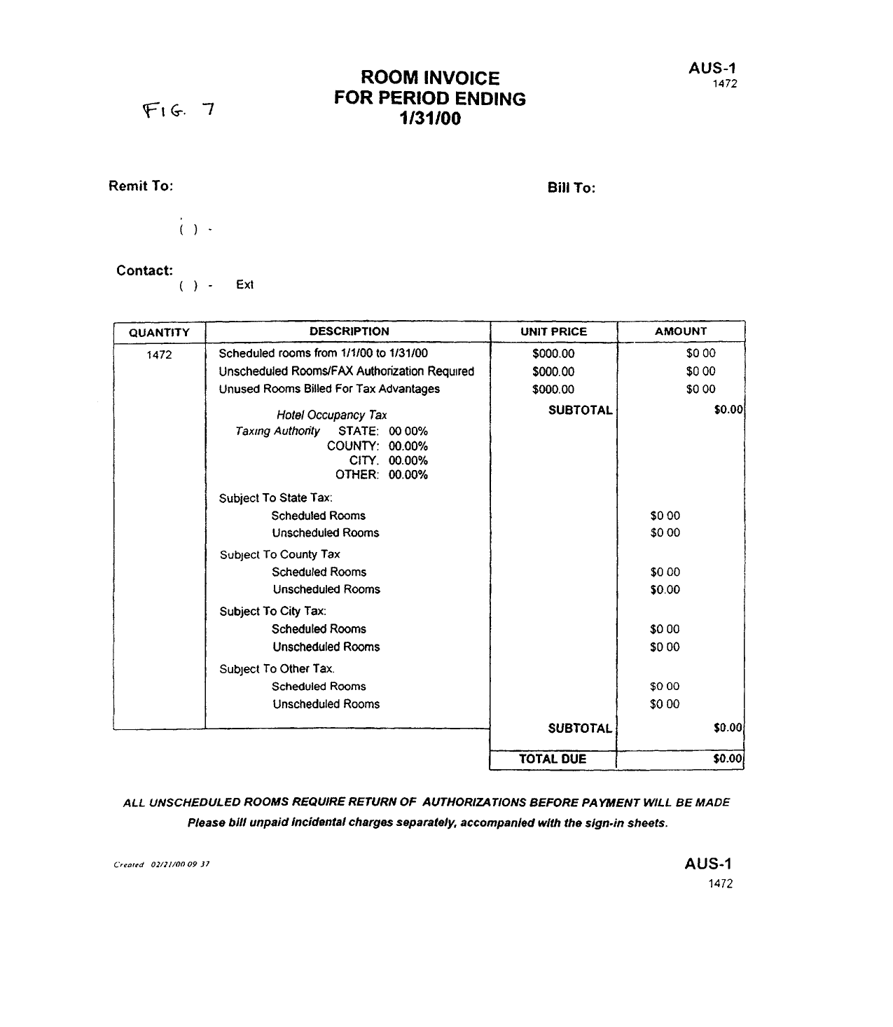

The packaged file provided and the program installed in and used by the hotel computer system allows the hotel to print the complete report or sheet for the entire time period or a portion of a report or sheet. In addition, the system facilitates the creation of a monthly invoice by the hotel. This invoice contains information entered by the hotel that contains the hotel name, billing address, billing contact name, number of scheduled rooms used, number of unscheduled rooms used, rooms subject to tax, state, county city and other taxing information, contracted room costs. It also has the airline billing address and contact information. At the end of the time period, a standardized detailed invoice is then generated that is sent back to the airline with the filled in sign-in sheets. This allows bill payment and detailed auditing of the airlines room usage including determination of amount of taxes paid and any refunds or reimbursement thereof resulting from special room usage tax rules. A typical invoice is shown in FIG. 7.

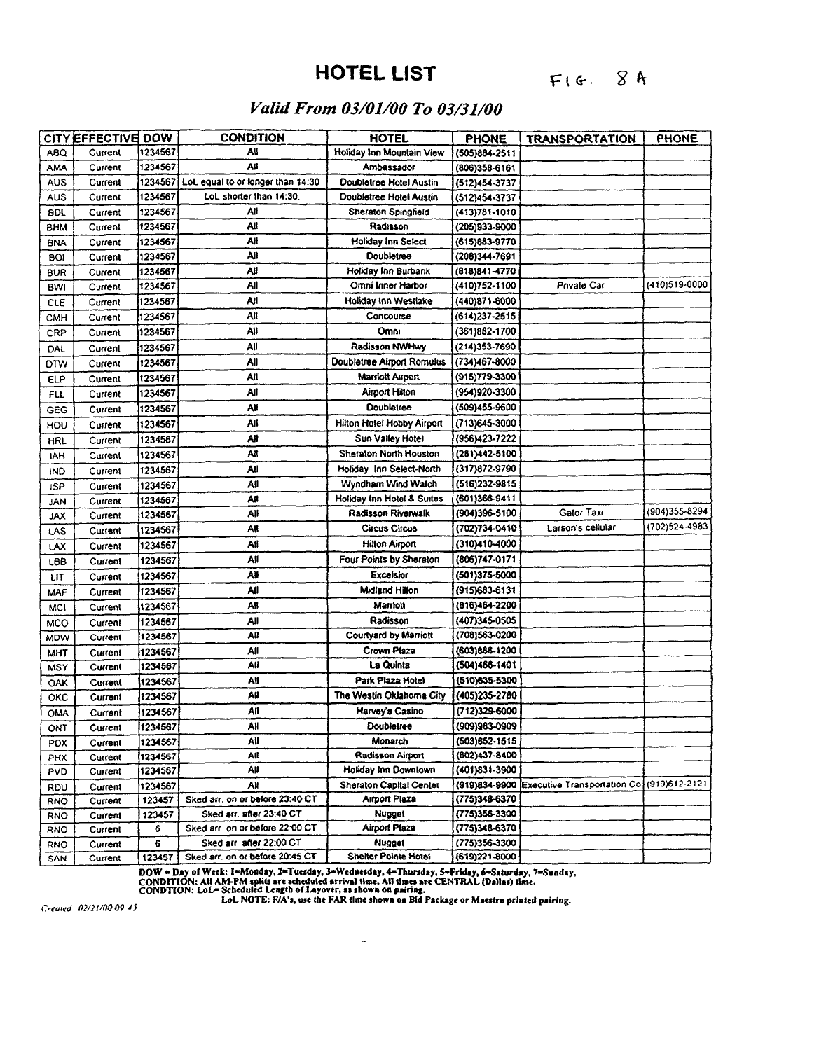

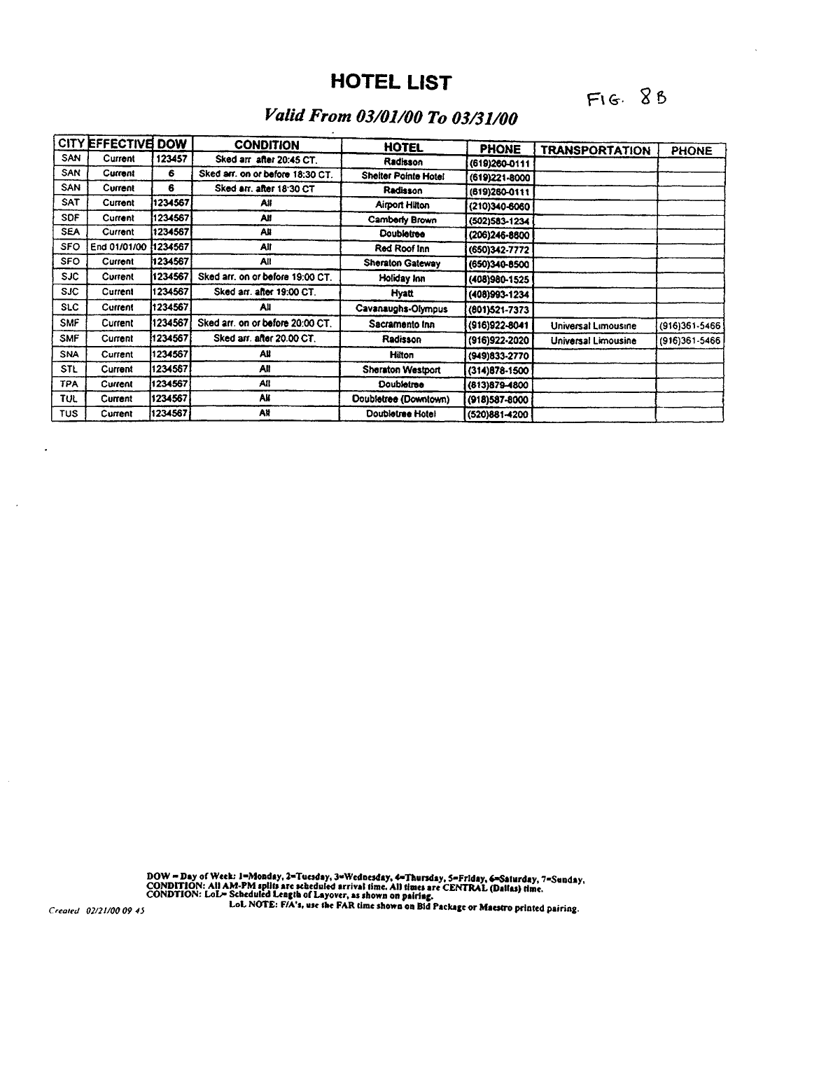

In addition to the above reports, the system creates for use by the carrier (but not for transfer or use by the hotels) other lists and reports for a specific time period. One list is a list of all primary contracted hotels that includes the city, the status of the contract between the hotel and the carrier (whether current or becoming effective sometime during the subject time period), the conditions for using the hotel, the hotel name, the hotel number, third party transportation, if any, and the telephone number of that party. A typical hotel list is shown in FIGS. 8A and 8B.

Another list is a list of all primary and alternate contracted hotels that includes the city, the status of the contract between the hotel and the carrier (whether current or becoming effective sometime during the subject time period), the conditions for using the hotel, the hotel name, the hotel number, third party transportation, if any, and the telephone number of that party.

Another report is a carrier room requirement for a particular time period. It includes an identification of the hotel and the city, each day of the particular time period, the number of rooms required for cockpit crew members and the number of rooms required for cabin crew members for each day and the total numbers of rooms for each hotel (with subtotals for cockpit crew members versus cabin crew members) for the subject time period.

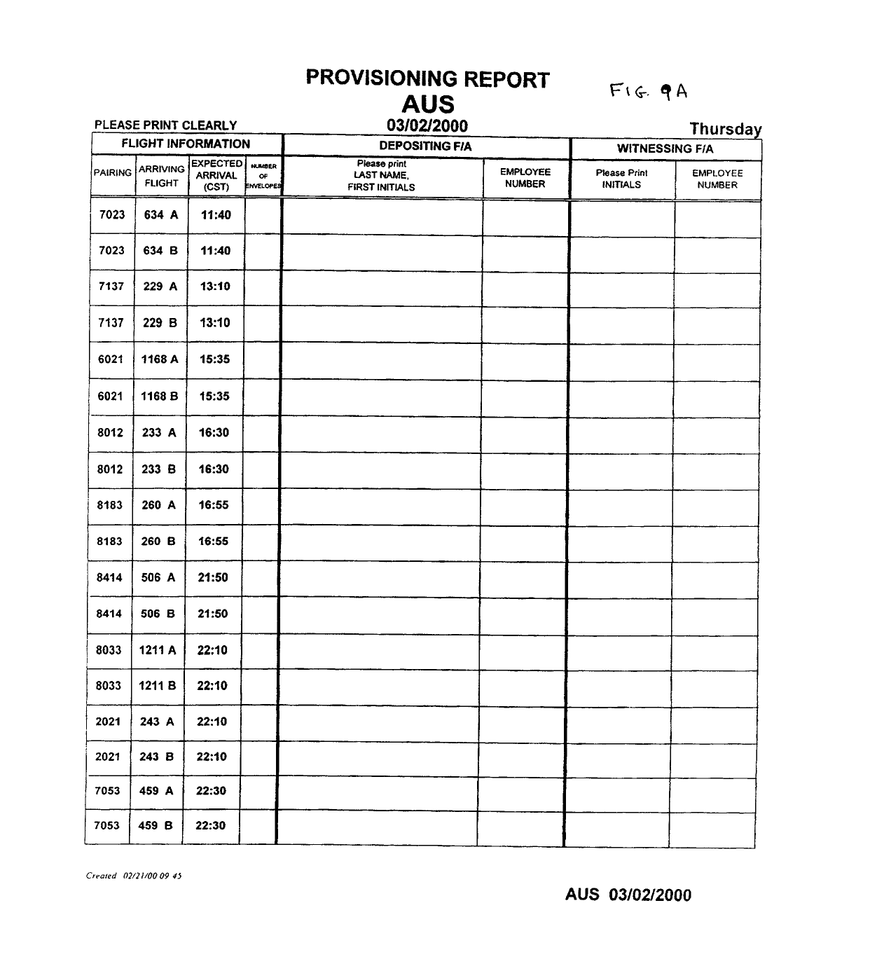

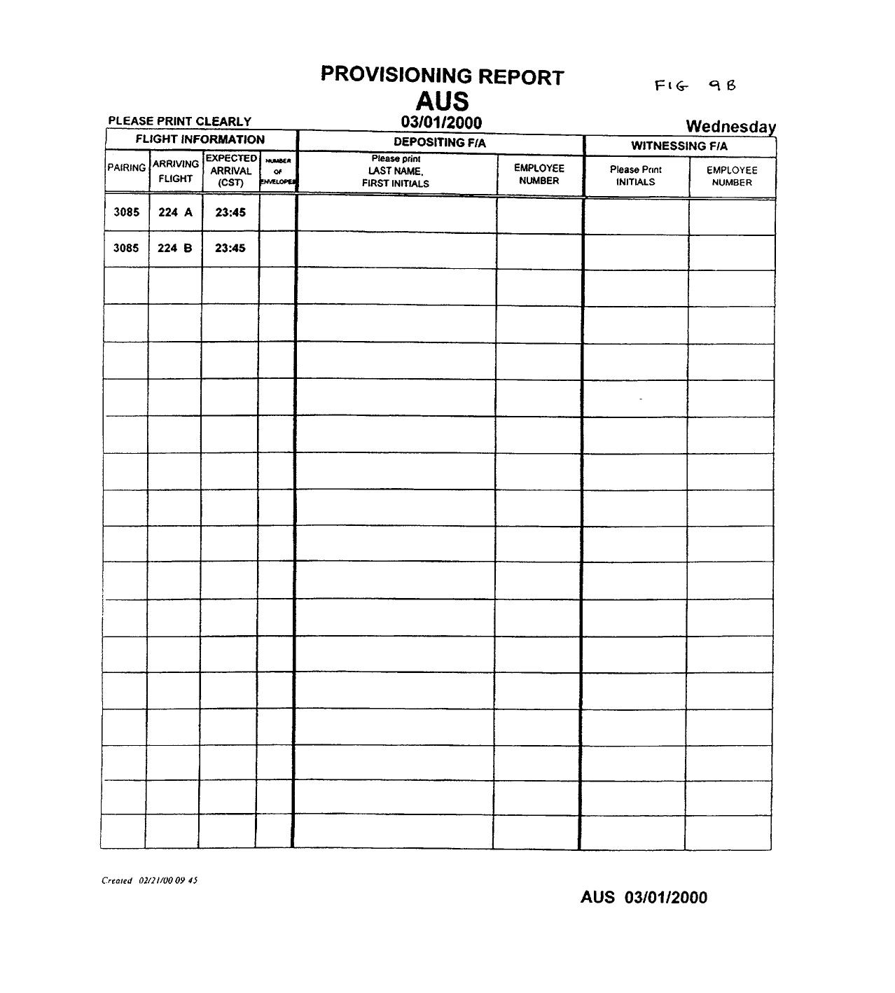

Still another report generated by the system in accordance with the present invention is a Provisioning Report which is generated for each destination city on a daily basis for reporting the deposits of envelopes containing money received from the sale of drinks in flight. The report includes the name of the city; the date; the pairing number; the arriving flight number; the expected arrival time; and place for writing the number of envelopes being deposited, and the name and employee number of the depositing flight attendant. A typical provisioning report is shown in FIGS. 9A and 9B.

The database that is generated at the airline facility and which encompasses all the above reports can be exported to any third party in a form suitable for use by that party, such as ASCII form. Accordingly, the third party can readily process and use that information.

The above description is of preferred exemplary embodiments of the present invention, and the invention is not limited to the specific forms shown. Modifications may be made in the design and arrangement of the elements within the scope of the invention, as expressed in the claims.

What is claimed is:

1. A method for managing the overnight accommodation of people in an establishment that provides lodging, comprising:
generating a data file in a computer readable form;
transferring the data file to the establishment in a computer readable form; and
creating a printed form of data from the data file at the establishment.
